(19) United States
(12) Patent Application Publication
(10) Pub. No.: US 2004/0133804 A1
(43) Pub. Date: Jul. 8, 2004

(54) System and method for automated biometric data collection

(76) Inventors: Evan Ronald Smith, Manassas, VA (US); Donna DeShields Rilee, Sterling, VA (US)

Correspondence Address: EyeTicket Corporation, Suite 713, 8201 Greensboro Drive, McLean, VA, 22102, US

(21) Appl. No.: 10/359,538

(22) Filed: Feb. 7, 2003

Related U.S. Application Data
(60) Provisional application No. 60/354,287, filed on Feb. 7, 2002.

(51) Int. Cl. H04L 9/32

(52) U.S. Cl. 713/201; 713/186

(57) ABSTRACT

A biometric recognition system enrolls individuals with minimal data keying and expedited processing at the point of biometric data collection. Personal data is obtained initially from an existing database, an identity document reader, or a data entry form available at multiple locations, such as an Internet web-based form. Based on the personal information received, any necessary background checks are completed and the individual is authorized to enroll in the system. The individual appears at a biometric data collection station with at least one identity document. The document, the individual, and the stored personal data are matched and verified, and biometric data is collected and stored in linkage with the personal data of the individual.

### CROSS REFERENCE TO RELATED APPLICATIONS

This application claims the benefit of U.S. Provisional Patent Application Serial No. 60/354,287 filed Feb. 7, 2002.

### FIELD OF THE INVENTION

The invention relates to systems and methods for collecting biometric data used to identify persons, such as for passport control, access to secure areas, and/or the delivery of goods, services, and transportation.

### BACKGROUND OF THE INVENTION

Traditional token-based identification methods rely on identity documents issued to a person. Examples include passports, driving licenses, military service identification cards, and government benefit identifications. These forms of identification are susceptible to forgery and fraud.

The field of biometrics is concerned with identifying people by unique physical characteristics. Numerous biometrics identifiers have been developed and tested, including iris recognition, facial recognition, fingerprint recognition, and identification methods based on hand geometry, retinal scans, voice patterns, movement patterns, and handwriting or signature analysis. Biometric identification is potentially more accurate and less prone to fraud than traditional token-based identification methods. Biometric systems can be used for identification, and for verification of an asserted identity.

In establishing a biometric identification system, it is necessary to enroll users in the new system by satisfactorily determining the identification of each user and collecting and storing the biometric data that will be used thereafter as an identifier, and linking the biometric data to the user identification information.

Heretofore, this enrollment process has been conducted as a substantially manual process where identifications are checked, data is keyed into a system, and biometric data is collected and stored. With the introduction of biometric systems into popular use for mass public applications, as exemplified by the successful trial of EyeTicket Corporation's JetStream™ traveler processing system at London Heathrow Airport, there is a need for improved methodologies of handling biometric enrollments, particularly high volume enrollments.

### BRIEF SUMMARY OF THE INVENTION

Individual are enrolled in a biometric recognition system using a process that minimizes data keying efforts and expedites processing at the point of biometric data collection. Personal data is obtained initially from an existing database, an identity document reader, or a data entry form available at multiple locations, such as an Internet web-based form. Based on the personal information received, any necessary background checks are completed and the individual is authorized to enroll in the system. The individual then appears at a biometric data collection station with at least one identity document. The document, the individual, and the stored personal data are matched and verified, and biometric data is collected and stored in linkage with the personal data of the individual.

### BRIEF DESCRIPTION OF THE DRAWINGS

FIG. 1 is a block schematic diagram of an embodiment of a data collection system according to the present invention;

FIG. 2 is a flow diagram illustrating an embodiment of the data collection method of the present invention;

FIG. 3 is a data flow diagram showing a method of transmitting and processing information to support biometric data collection; and

FIGS. 4a and 4b together make up a sample of an expedited passport control application form adapted for web-based applications used in some embodiments of the invention.

### DETAILED DESCRIPTION

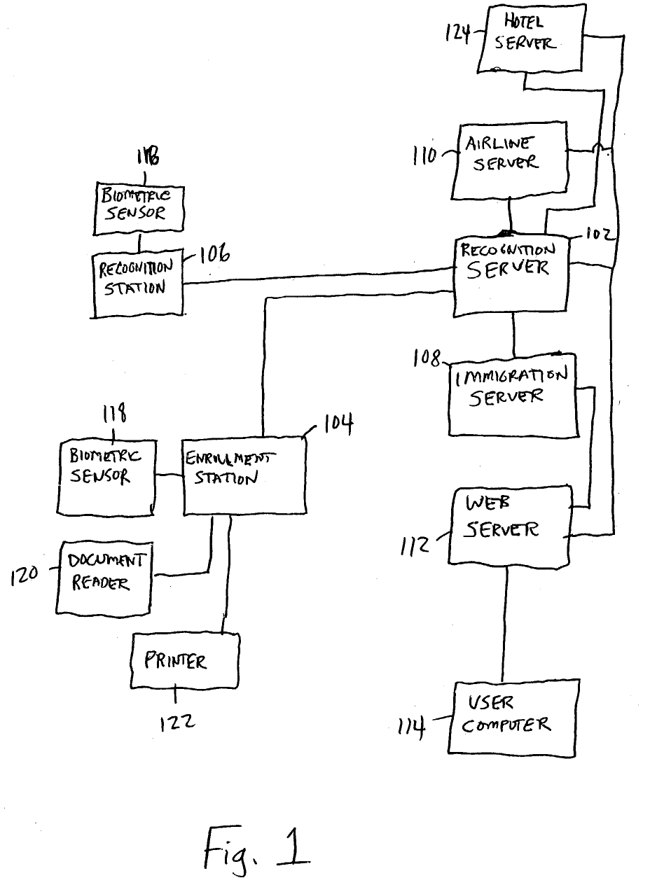

FIG. 1 shows a system according to the present invention in block schematic form. Recognition server 102 is connected to one or more enrollment stations 104 and recognition stations 106. Recognition server 102 is also connected to immigration data server 108 and to web server 112. Recognition server 102 may also be connected to servers belonging to other organizations, such as airline server 110 and hotel server 124.

Recognition server 102 preferably runs biometric identification server software that performs the function of storing, processing, and comparing biometric templates received from client units such as recognition station 106 or enrollment station 104. In the case of enrollment station 104, recognition server 102 receives templates for storage to facilitate recognition of the person providing the template. In the case of recognition station 106 recognition server 102 receives a template, matches it to a corresponding template in the database, and provides identification information to immigration server 108, airline server 110, hotel server 124, or another organization's server. Those servers may return to recognition server 102 information to be displayed or printed, or instructions regarding actions to be taken, such as dispensing a hotel key card or opening an automatic gate, and recognition server 102 will provide appropriate instructions to recognition station 106 to perform those functions.

The operation of the iris recognition system, servers, and other components is described in more detail in U.S. Pat. No. 6,119,096 to Mann et al. and in co-pending application Ser. No. 09/365,167 titled “System and Method for Managing Access to Transportation Systems”, the disclosures of which are incorporated herein by reference.

Information stored for operation of the biometric identification system includes, generally, biometric data (sometimes referred to in the field as a biometric template) and other personal data. In one embodiment, all of this information is stored in a single database in a single server. In other more flexible embodiments, the biometric data is stored in a separate database from at least some of the other personal information, but linked thereto by a common record key system. These options are disclosed in more detail in U.S. patent application Ser. No. 09/439,288 and titled “System and Method for Managing Reservations and Boarding for Plural Transportation Carriers” filed Mar. 10, 2000 and assigned to the assignee of the present application, the entirety of which is incorporated herein by reference.

Enrollment station 104 may include biometric sensor 118, document reader 120, and printer 122. Biometric sensor 118 may be any biometric sensor, including iris recognition, fingerprint recognition, facial recognition, hand geometry, retinal scan, voice recognition, handwriting analysis, movement patterns, or any other biometric. In a preferred example, biometric sensor 118 is an iris recognition camera that captures iris pattern information for processing. Document reader 120 is an appropriate automated document reader for verifying identity documents. The nature of reader 120 will depend on the function for which enrollment is performed. For example, for expediting passport control, reader 120 is preferably a passport reader such as the Falcon full page passport reader manufactured by Canadian Bank Note Co. of Ottawa, Ontario, Canada. For enrollments directed to expediting credit card transactions, a credit card reader might be provided. Driving license, frequent flyer card or other document readers, or document readers capable of reading a plurality of document types may be provided to support other types of enrollments. More than one document reader may be provided if the enrollment station is used for multiple purposes or if the application approval process requires more than one document.

Web server 112 is connected to recognition server 102, and to other servers such as airline server 110, hotel server 124, and immigration server 108. Web server 112 is connected to the Internet and provides access, via a standard web browser, to an application form or forms used to join expedited processing services supported by the system. For example, persons may apply with an immigration service to join a passport control expediting service wherein they can receive automated passport control processing based on a biometric identifier. Similar expediting services may be provided for hotel check-in, airline check in, baggage check, and boarding, credit card and other payments, and any other commercial or government functions which can be expedited with positive identification of the individual.

The identification or recognition station 106 has a biometric sensor 118 such as an iris recognition camera. This station acts as a client to recognition server 102 and includes a computer running client software for obtaining iris or other biometric data and sending it to the server for identification and instructions. Station 106 can, for example, operate to identify a pre-cleared and approved arriving airline passenger, issue a “leave to enter” ticket, and open a gate to allow the passenger to bypass the normal passport control queues in an immigration arrivals hall. In this manner, the known, pre-cleared passenger is expedited and permitted to pass through immigration in seconds, in an automated and substantially unattended manner.

The examples described herein operate primarily for identification rather than verification. However, either can be selected. The inventive methods disclosed herein operate effectively for verification of an asserted identity, by scanning an identification token carried by the user and then matching real-time biometric information against information stored for that user or against information carried by the user on the token or otherwise. The system may also operate in identification mode, such as one-to-many identification where real time biometric information is collected and checked against a database of possible matches to produce a single match identification. The inventive methods herein will also accommodate hybrid modes of operation combining features of identification and verification. For simplicity the term “identification” will be used herein and in the claims to refer to recognition in general, whether identification, verification, or a hybrid thereof.

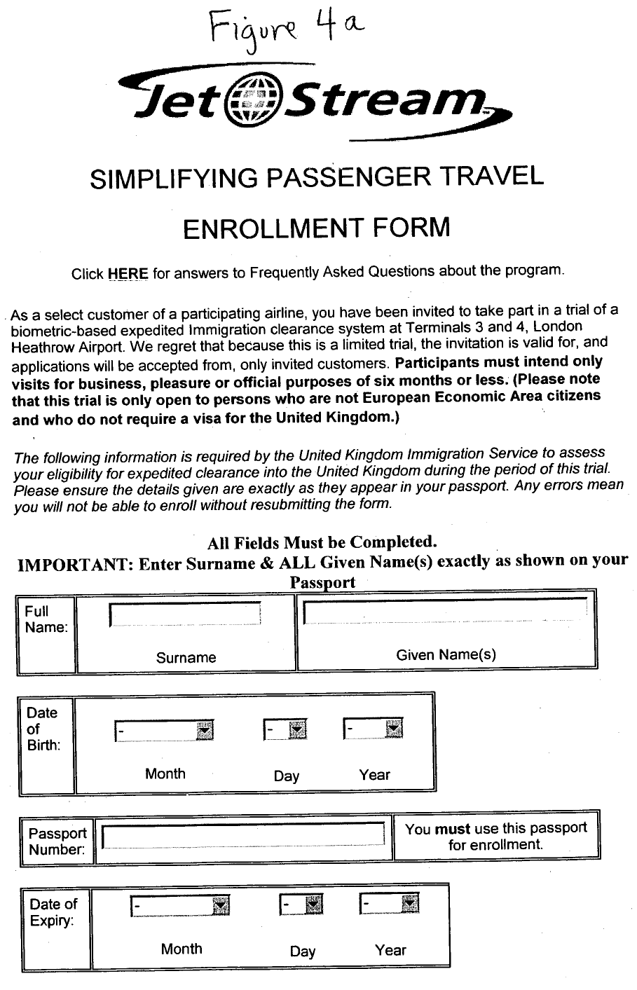

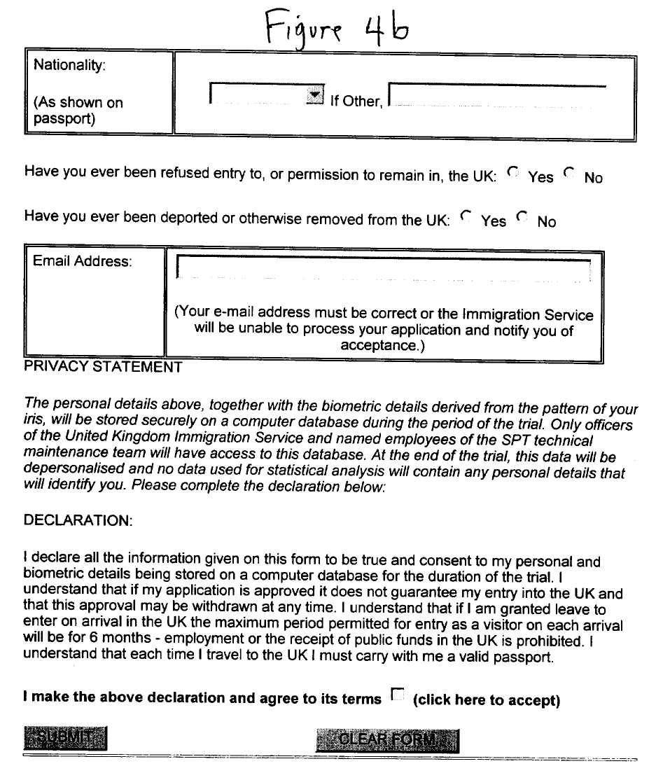

A sample application form for an immigration passport control expediting service is shown in FIG. 4. Appendix A is a summary of one embodiment of operation of the application processing and biometric capture method of the present invention. Appendix B shows a sample enrollment script for one embodiment of an iris-recognition based passport control expediting service. While the invention is described herein primarily in terms of an example system for expediting passport control functions, the same processes can be applied to enroll individuals for any desired biometric identification function, such as expedited airline passenger processing, hotel check in, car rental, credit card payments, government benefits determinations, and other commercial and governmental functions.

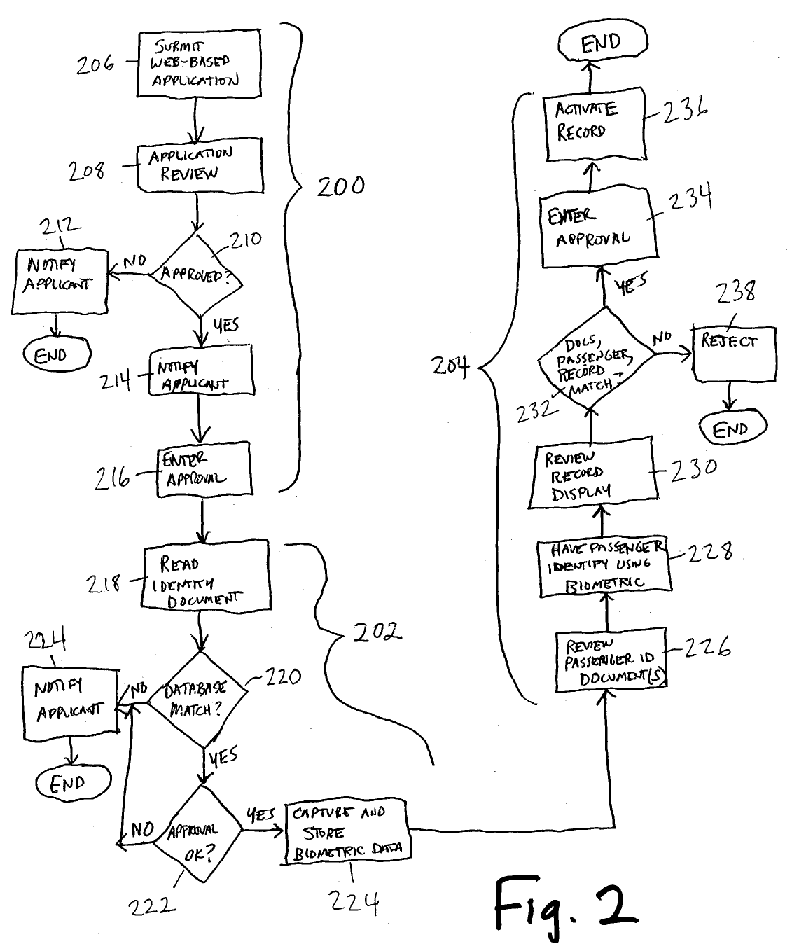

FIG. 2 is a flow diagram showing a preferred process for registering passengers for expedited passport control.

The embodiment of FIG. 2 provides a process having sub-processes for enrolling passengers in a biometric identification system, such as a passport control expediting system. These three sub-processes are application step 200, biometric capture step 202, and ID verification step 204. In a first embodiment steps 200, 202, and 204 are performed in that sequence. In an alternative embodiment, ID verification step 204 is performed prior to biometric capture step 202. In other embodiments, the steps disclosed are performed in any sequence appropriate to the particular application, and the invention contemplates that some of the steps disclosed may be omitted or other steps added.

As shown in step 200, travelers submit an application to a control authority via the World Wide Web in block 206, keying in relevant passport data and other information as required. Examples of information that may be collected include, without limitation, name, gender, date of birth, date of document issue, date of document expiration, address, telephone and other contact information, and nationality. The information collected varies depending on the application and the preferences and requirements of the operating authority. The collected personal information is placed in the application database in a database record. In block 208, the application is reviewed by the control authority. Approval or disapproval is determined in block 210 based on criteria determined by the controlling organization. For example, the person may be checked against one or more watch lists. If the applicant is rejected for any reason control passes to block 212 and the applicant is notified. If the applicant is approved, control passes to block 214 and the applicant is notified of approval and given directions to enrollment centers which may be located as desired, using fixed or portable enrollment stations. In block 216 an indication of the approval of the traveler is stored in the system, preferably linked to or made a part of the database record established for the traveler at the time of the application. The approval indication may be entered manually or may be a flag generated automatically by an automated approval system.

At the enrollment location, the identity document is read in block 218. In the case of the passport control application example used herein, the approved traveler provides his/her passport, which is read rapidly by a full-page passport reader. Next, in block 220, the scanned passport data is used to find a database match to the approved application record. For example, the passport reader obtains the passport number and the database is then searched for a record including a matching passport number. Next, optionally, the system may determine whether all data matches. That is, other machine-readable information on the identity document may be verified against the information entered by the traveler during the application phase and stored in the database record. In cases where a background check or watch list check has been performed based on the data supplied, the integrity of that check depends on the accuracy of the information used in the search, such as name and date of birth. Thus, any desired machine readable data elements from the identity document may be checked against the database record for accuracy. In one embodiment, the surname, first given name, and date of birth given in the application are required to match the identity document in order to proceed with enrollment. If there is a mismatch, an indication is provided and control passes to block 224.

When the traveler's database record has been located and matched to the extent necessary, control passes to block 222. If no matching record is located, or if critical data in the record does not match the data on the identity document, control passes to block 224 and the applicant is notified either that no application matching his or her passport number has been received, or that the data was not entered correctly. The “no application” error may occur because the applicant mis-typed the passport number in the on-line application, or because the person did not submit an application.

Next, in block 222, the system is checked for an approval indication that was stored at the time of review and approval of the application. If there is no approval present, the traveler cannot be permitted to use the automated identification system. In this case control passes to block 224 and the traveler is notified of the problem.

If desired, the biometric data can be captured even if there is a data mismatch or the traveler is not approved, in case of a later change of status or correction of error. In most cases, since these problems make it uncertain that the traveler will be permitted to use the system, and to avoid any possibility of erroneous identification, the process of capturing and storing biometric data is bypassed if there is not a correct, approved record in the system.

In block 224 the traveler's biometric data is stored. In a preferred embodiment, iris pattern data is stored. The traveler presents each eye to an ordinary video camera for several seconds. An image is captured, pattern data (the biometric template) is instantly extracted from the image and stored, and the image is discarded. Any desired data from the passport (including photo data) can be stored in the database as required. This iris capture process is fast, automated, and requires no special operator skill, intervention, or other considerations to create a repeatable, accurate template. The passenger is then fully briefed on using the automated recognition system and practices recognition several times to gain facility with presentation of the iris to the camera. Location of the passenger's approved record and iris capture take only seconds. Briefing and practice are the more time consuming functions. Enrollment operators require customer service training but need no special technical expertise. A manual passport or other ID data entry capacity (data entry screen) is provided in case of reader failure or in case the document is not machine readable.

In another embodiment, the steps shown in FIG. 2 are performed sequentially at a single location. In this embodiment, application step 200 is performed by keying in any required personal information not included in the identity document that is, however, desired for system operation. If no information is needed for the individual record beyond information that is machine readable from the identity document, and if a rapid automated approval process is available, the traveler may bypass submitting the application in advance and simply present his or her identity document at the biometric capture station. The system will then read the identity document and automatically process and approve the application based on the machine readable data from the document. Thereafter, biometric data can be captured and stored and the individual can use the biometric identification system. The process of verifying the individual's identity can be performed as a separate step, or the document and individual can be examined and compared while an authorized person receives the identity document and places it in the identity document reader.

As an option for enhancing background check capability, one biometric may be collected and used for performing background checks while another biometric is used in the automated biometric identification system. For example, fingerprints may be collected and used for background checks at the time of enrollment because of the availability of national and international Automated Fingerprint Identification System (AFIS) databases. However, iris recognition may be selected for real-time identification and passenger processing because of its greater speed and accuracy level. Background checks performed with a biometric such as a fingerprint biometric can be performed in real time or can be processed later. If the background check will be conducted later, the traveler whose biometric data was collected may be authorized to use the automated system when biometric data collection and identity verification are completed, or there may be a delay in activation of the new record to allow time for the background check based on the other biometric information.

As can be seen, in the preferred embodiments there is no substantial data keying required at the biometric capture stage, since personal data has already been collected through the application process and/or by machine reading the identity document. This advantageous feature minimizes keyboarding errors and speeds the enrollment process by offloading data entry and proofreading functions to the traveler.

Referring now to sub-process 204, as a final step before the traveler's record is activated to permit national entry, in one embodiment an authorized officer (typically located at an airport) conducts an in-person review of the passport in block 226. In block 228, the traveler is biometrically identified using the same biometric captured and stored in block 224. For example, the traveler looks into an iris recognition camera connected to the system for positive identification and matching with the traveler's database record. In block 230 the individual's record is retrieved in response to the biometric identification and displayed for review. In block 232, the officer determines whether the passport is valid and appears to match the traveler. If so, control passes to block 234 and the officer is prompted to enter a code to indicate that he or she has validated identity for the traveler record. The record is then activated in block 236 and the biometric identification system is activated for use by that traveler. In the case of a passport control system the traveler will be permitted to use biometric identification for expedited national entry. Preferably the biometric identification system is activated to permit use by the traveler only when (1) the traveler is approved for use (2) biometric data has been captured and stored, and (3) traveler identity has been verified by an authorized officer.

In the embodiment just described, sub-process 204 is established as a separate process including biometric identification of the traveler to locate the traveler's established record. This arrangement makes it possible to perform this sub-process at a location and/or time different from the location and time of sub-processes 200 and/or 202. This flexibility provides a useful advantage and makes possible various operating options, including (1) allowing persons other than authorized officers to conduct the initial machine reading of the identity document and the capture of biometric data, and (2) allowing a single authorized officer at a separate station to verify identity for the individuals processed by more than one registration station. Detection of forged passports and other identity documents and the ability to determine whether an individual is the one pictured on an identity document each require training and experience, such that it is desirable to minimize the number of persons involved in an enrollment operation who must be proficient in these areas. Identity verification may also be performed as part of the biometric data capture process, as part of the initial application process, or prior to either or both of these other processes.

For the iris recognition example, the identification process is even faster and easier than the registration process. Capture of an iris image and one-to-many matching against the server database typically occurs in one to two seconds. The user merely looks into the same type of automated video station used during enrollment, and positive identification is assured. Identification stations may be configured to print receipts, communicate data to existing systems, communicate data to or from a handheld electronic device, and operate barrier gates, including a variety of anti-tailgating portals. Data can be collected during the identification process via touch-screen or personal digital assistant (PDA) wireless interface.

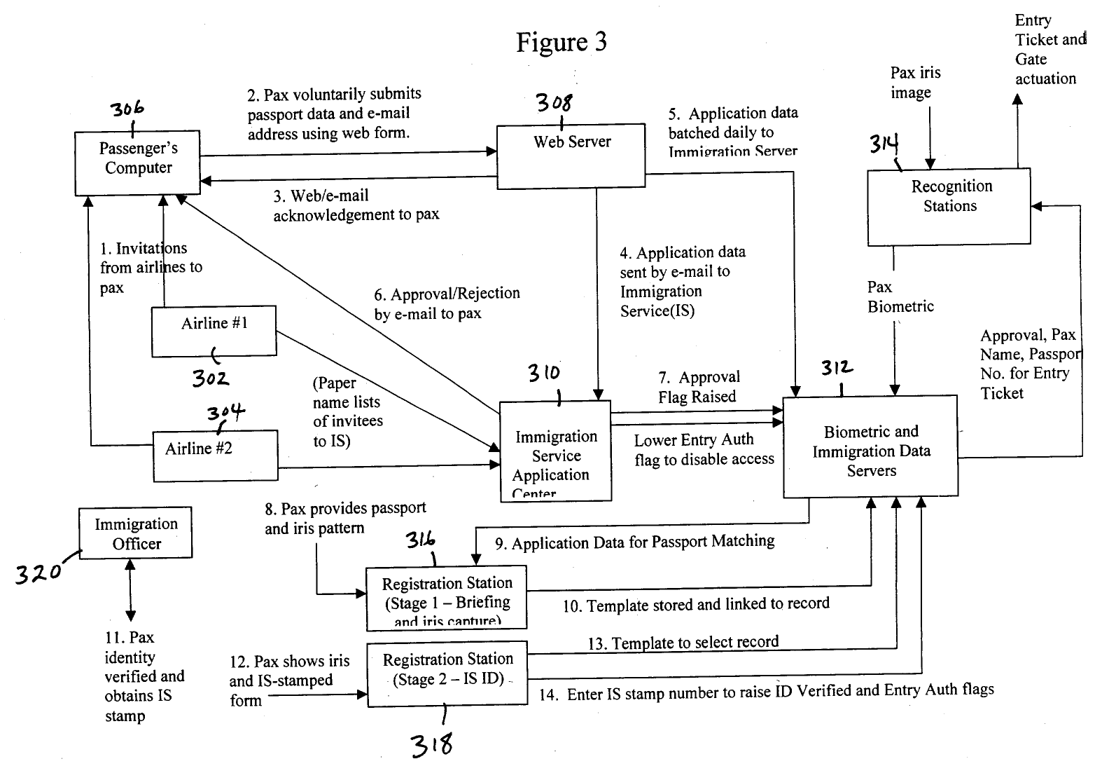

FIG. 3 is a data flow diagram showing the operation of one embodiment of the system as described above for biometric enrollment for expedited passenger processing. The indicated steps 1 through 14 are performed in any appropriate order, but preferably in the order shown, to invite passengers to enroll, obtain their application data, conduct pre-clearance, notify the passenger, capture biometric data, and verify identity of the passenger relative to the ID documents. Referring now to FIG. 3, in step (1) one or more airlines 302, 304 invites one or more passengers to enroll in an expedited passenger processing program. These invitations may be sent by any method, for example by electronic mail to passenger computer 306. The invitations include a link to an Internet uniform resource locator (URL) defining a location for a registration form or application that can be viewed with a standard web browser. The passenger clicks on the link and in step (2), the passenger submits key passport data elements and their e-mail address using the web form.

The registration form may, for example, take the form shown in FIGS. 4a and 4b. Referring briefly to FIGS. 4a and 4b, the sample form requires the passenger the submit surname, given names, date of birth, passport number, date of passport expiration, nationality, and e-mail address. The applicant may be required to answer questions such as “Have you ever been refused entry to, or permission to remain in, [nation]” and “Have you ever been deported or otherwise removed from [nation].” Data fields in this form may be added or deleted as desired depending on the application and the requirements of participating organizations. Information on system operation, personal privacy, and regulations may be given on the form. Authorization to store and use biometric data, and understanding and acceptance of the terms set forth may be indicated by an affirmative selection (see “click here to accept”) by the passenger as part of the application process.

Referring again to FIG. 3, when the passenger clicks on “submit” the application information is sent to web server 308 and a passenger record is created in a database. The application data is provided to authorized agencies for review and processing. For example, in the case of a passport control expediting system, the information may be sent to the national immigration service for approval. The information may be sent in real time, in batch mode, or in the example shown, by electronic mail (step (4)). In step (5) the database record is transmitted to a data server or servers 312, for example an immigration data server controlled by the immigration service, and added to a passenger database there. The data may be transmitted in real time or in batches.

In step (6), after the immigration service performs appropriate background checks and determines whether the individual is qualified to use the biometric system, an approval or rejection is sent to the passenger, such as by electronic mail. If the individual is approved, in step (7) an approval flag is raised in the database record or in a location associated with the database record to indicate the approval.

In step (8) the individual appears at a registration station 316 and provides an identification document, such as a passport, as identification. The passport is scanned and the machine readable information is used to bring up the individual's approved record from servers 312 in step (9), in the manner described above with reference to FIG. 2. The individual's biometric data, such as iris pattern data, is then captured and stored in step (10) and linked to the individual's data record to facilitate subsequent identification matching. If the identity verification process is to be accomplished at another place, the individual is given a printout with information identifying their record and takes the printout and their identification to an authorized officer for verification. In step (11) the officer verifies identity and stamps the form. In step (12) the passenger returns to the registration station for stage 2 of the registration process (318) and shows the stamped form. The passenger is recognized biometrically based on the data already stored (such as by presenting their iris to a camera), and the real time data collected is transmitted to servers 312 in step (13) and used to match and locate the relevant record. That record is then brought up at registration station 318 and in step (14) the immigration service stamp number is entered. This entry completes the process and raises both the “ID verified” and “entry authorized” flags associated with the record. At this time, the approval flag, the ID verified flag, and the entry authorized flags are all raised, permitting the individual to use the biometric identification system at will. The controlling authority, in this example the immigration service, may at any time disable access by the individual by lowering the entry authorization flag associated with that person. The data stored to determine whether these steps have been complete and whether access is authorized have been described as flags, but another indicia or a characteristic, state, or existence of a data record may be used as an indicator in a similar manner.

It should be understood that the examples described in detail herein are embodiments of the invention, but that the invention is not limited to these embodiments. The inventive concepts and methods disclosed are equally applicable and can be readily adapted by those skilled in the art to biometric enrollment for other systems and purposes, such as airline passenger processing systems, ticketing, check in, baggage check, baggage matching, boarding, hotel check in, car rental, visa processing, passport control for both exit and entry, credit card transaction processing, government benefits processing, voter registration, parent-child identity matching, prisoner identification, employee identification, time clock systems, access control, flight crew identification, and any other biometric application. As an example of one modification, in cases where a large number of persons are to be enrolled and a database containing personal information for those persons already exists, data from that database can be brought up by presentation of an identity document, rather than data entered manually by the person in an application form. This variation is particularly useful for enrolling voters, employees, or crew whose personal data is already in a database and where it is only necessary to collect biometric data and link it to those records.

Thus, a system has been described which rapidly and effectively enrolls high volumes of passengers in a biometric expediting system with high identification confidence, and minimal keyboarding and data entry effort on the part of the participating organizations.

### Appendix A

### Registration Process Summary

1. Passenger Application

Passengers complete all mandatory fields in on-line application form

2. Application Transmission

Passenger clicks ‘submit’

If any mandatory fields not completed, form is returned to screen with message to this effect

OK form is sent to a predetermined mailbox at the controlling organization

Message appears on passenger's screen to notify that form has been sent

E-mail acknowledgment sent to passenger's e-mail address from on-line server, with controlling organization return address.

Details from form are also added to the controlling organization database as unapproved pending applications

3. Application Processing

Controlling organization prints out each individual application form received at mailbox

Controlling organization checks name and information against invitation list if appropriate.

Controlling organization determines approval or rejection

Appropriate notice sent to the passenger's e-mail address

4. Entering Application Acceptance in Database

If passenger not approved (does not meet criteria), then controlling organization deletes passenger's details from the database

If passenger is approved, controlling organization enters approval number in database and raises the Approval flag

5. Registration

Only passengers who have submitted an application, received approval, and successfully completed each of the following two stages of the registration process will have a raised “Entry Authorized” flag and be able to use the expedited system (e.g. activate an automated gate for passport control and enter the country unattended).

Stage 1—Passenger Briefing and Initial Iris Capture

Enrollment station personnel scan passenger's passport and this brings up record from controlling organization database if there is a match

If there is no match, enrollment cannot proceed

If there is no approval number, and the Approval flag is therefore not raised, an error message to this effect will appear on the screen

If there is an approval number and the Approval flag is therefore raised, enrollment station personnel collect biometric template which is stored in a separate database, with a unique record key linking each entry to the corresponding record in the controlling organization database.

Enrollment personnel brief passenger on operation and allows passenger to practice identification process.

Stage 2—Identification

A copy of the database record showing approval may be printed if desired to produce an audit trail for identity verification.

An official of the controlling organization (example: Immigration Officer) checks identity.

For example, an immigration officer would check:

passport for apparent authenticity

that passenger and passport photo match

An official stamp may be placed on the printed copy of the database record, and that copy can be saved for ID audit purposes.

Passenger provides biometric identification (e.g. looks into iris camera) to identify himself and bring up record for entry of ID verification approval.

The official's identifying information is entered on screen and stored in database, and an Identity Verified flag is raised in response to entry.

Entry Authorized flag is raised, if and only if there is now a completed registration, raised Immigration Approval flag, and raised Identify Verified flag in the record.

Enrollment personnel collect stamped approval form.

6. Deactivating an Account

To deactivate an account, the control authority can lower the Entry Authorized flag, rendering the account inactive.

### Appendix B

### Sample Passenger Registration Script for Passport Control

Welcome and Identification

“Welcome, have you come to register?”

“May I see your passport?” (scan passport to bring up database record. If passport will not scan, enter data manually from passport)

(In case of a data mismatch) “I'm sorry, the (birth date/surname/given name) on your passport doesn't match the information entered in your application. I apologise for the inconvenience but we will need to submit the correct information to the Immigration Service. They will contact you to let you know when you can come back and register. You see, the validity of your pre-clearance by the Immigration Service depends on their having the correct information in advance.”

(In case no matching passport number is found in the database) “We don't have a record that matches this passport number. Did you fill out the application form on the Internet?”

(If passenger did not fill out application form) “Did you receive an invitation from an airline?”

(If passenger was invited) “A pre-clearance check by the immigration service is required before we can register you. We will have to get your application now, and register you after you receive approval from immigration.” (Invite passenger to fill out paper application.)

(If passenger was not invited) “I'm sorry, we are only registering invited passengers.”

(If passenger did fill out application form) “I'm sorry, there isn't a record matching this passport number. This may be because the passport number was entered incorrectly at some stage. I'm very sorry for this inconvenience. May I take down your information and get an e-mail address and telephone number? We will find out what the problem is and the immigration service will contact you promptly. Then we can register you next time you are in the terminal.”

(In case the record is located, but has not been approved by Immigration) “We have the record of your application, but the immigration service has not entered an approval in the system. Did you receive an approval letter from the immigration service?”

(If no approval received) “When did you fill out the application?”

(If less than one week) You should receive an approval within 7 days of your application. Unfortunately, for security purposes, the system doesn't allow registration until the approval process is completed. I'm very sorry for the inconvenience, but we will have to ask you to stop by next time, after you have received the approval.”

(If more than one week) “I'm sorry, we will have to check with the Immigration Service. May I take down your contact information so that they can get in touch with you?”

(If passenger says approval was received) “I'm sorry, there must have been an error in entering the approval. May I take your information so we can investigate the problem. Unfortunately, the system won't allow registration if the approval is not present. We will have the immigration service contact you promptly and after the problem is corrected we can register you.”

Explanation of the Registration System

(Call the Immigration Office at this time and request that they send an officer for ID verification)

“The station uses an ordinary video camera which merely takes a close up digital picture of your eye. The software will then store data representing the pattern in your iris, and the system uses that data to identify you when you enter through the expedited lane.”

(Demonstrate how to approach the camera while giving the following explanation) “The station has a sonar height sensor. The camera adjusts very quickly to your height as you pass under it and move your head near the camera (demonstrate). To use the station, pick one eye and look into the camera from about five inches away (13 cm) so you see that eye centered in the mirror.”

“Do you wear glasses or contact lenses?”

(If yes) The system typically has no trouble with contact lenses. You should remove your glasses for enrollment, so we can get the clearest possible image, but after that you can use the system with your glasses on. If you are wearing glasses you will need to be fairly close to the glass for good recognition.

(If no, proceed).

(Press “enter” to clear data screen and begin iris capture)

“Please go ahead and look into the camera with one eye.” (Guide passenger verbally to align first eye about five inches from camera and await image capture.)

“Now we'll do your other eye, the same way.” (If passenger has difficulty aligning either eye, invite passenger to cover the eye not in use with his/her hand.)

ID Verification

(Note, if the Immigration Officer is not yet present, begin practice recognitions, and interrupt practice for ID verification when the IO arrives)

(The IO will examine the passport, verify identity, and stamp the ID verification form. Put away each stamped form for safekeeping and daily delivery to Immigration. Then click on “ID Verification”)

“Please look into the camera to bring up your record.”

(Enter IO's stamp number from the ID verification form and press “enter”)

“Your registration is now complete and you will be able to use the automatic passport control station.”

At this time place a yellow sticker inside the back cover of the passenger's passport.

Practice Recognition

“Now we'll let you practice using the station several times.”

(If appropriate) “You can do this with your glasses on.”

(Conduct a minimum of four practices. Repeat as many times as necessary until the passenger is achieving instant recognitions and appears fully confident in using the system, providing guidance as appropriate)

Instructions for using the Passport Control Station

“when the station identifies you, it will welcome you with an audio message, print an entry authorization, and open the gate for you to enter.”

We claim:

1. A method for enrolling an individual in a biometric recognition system, comprising the steps of:
providing a data entry form accessible at a plurality of stations through a computer network;
receiving personal data of the individual over the computer network in response to entry by the individual of said personal data in said data entry form at one of said stations, said personal data including at least identifying information for an identity document of the individual;
storing said personal data in a database and inviting the individual to go to a biometric data collection station separate from said one of said stations;
receiving the individual together with said identity document at the biometric data collection station;
verifying a match between said identity document, the individual, and at least a portion of said personal data; and
collecting biometric data of the individual and storing said biometric data such that said biometric data is linked with said personal data stored in said database.

2. The method of claim 1 wherein iris pattern data is collected in said step of collecting biometric data.

3. The method of claim 1 wherein said biometric recognition system is a system for identifying travelers.

4. The method of claim 1 comprising the further step of determining, following said receiving personal data step and prior to use by the individual of the biometric recognition system, whether the individual meets predetermined qualifications for using the biometric recognition system and permitting use of the biometric recognition system only if the individual meets said predetermined qualifications.

5. The method of claim 4 including the further step of notifying the individual of the results of said step of determining whether the individual meets predetermined qualifications.

6. The method of claim 1 including the further step of using an automatic document reader at the biometric data collection station to read information from the identify document and using data from said automatic document reader to locate said database record for comparison.

7. The method of claim 6 comprising the further step of determining, following said receiving personal data step and prior to use by the individual of the biometric recognition system, whether the individual meets predetermined qualifications for using the biometric recognition system and permitting use of the biometric recognition system only if the individual meets said predetermined qualifications.

8. The method of claim 7 wherein said step of storing biometric data of the individual is completed only if the individual meets said predetermined qualifications.

9. The method of claim 1 wherein said plurality of stations are connected to a wide area computing network and said step of receiving personal data over the computer network is accomplished using at least one server connected to said wide area computing network.

10. The method of claim 9 wherein said server includes web server software and said data entry form is provided using a web browser.

11. The method of claim 10 wherein said wide area computing network is the Internet.

12. The method of claim 1 including the further step of storing an indication in response to verification that the identity document appears to match the individual.

13. The method of claim 12 wherein said indication is stored in said database record.

14. The method of claim 12 wherein said function of verifying that the identity document appears to match the individual is performed by human examination.

15. The method of claim 12 comprising the further step of denying the individual passage through the biometric recognition system in the absence of storage of said indication that the identity document appears to match the individual.

16. A method for enrolling an individual in a biometric recognition system for identifying travelers, comprising the steps of:
providing a data entry form accessible at a plurality of stations through a computer network;
receiving personal data of the individual over the computer network in response to entry by the individual of said personal data in said data entry form at one of said stations, said personal data including at least identifying information for an identity document of the individual;
storing said personal data in a database and inviting the individual to go to a biometric data collection station separate from said one of said stations;
receiving the individual together with said identity document at the biometric data collection station;
verifying a match between said identity document, the individual, and at least a portion of said personal data; and
collecting biometric data of the individual and storing said biometric data such that said biometric data is linked with said personal data stored in said database.

17. A method for enrolling an individual in a biometric recognition system for passport control, comprising the steps of:
providing a data entry form accessible at a plurality of stations through a computer network;
receiving personal data of the individual over the computer network in response to entry by the individual of said personal data in said data entry form at one of said stations, said personal data including at least a passport number from a passport held by the individual;
storing said personal data in a database record;
receiving the individual together with said passport at a biometric data collection station;
verifying a match between said passport number and the passport number entered by the individual in said data entry form;
verifying that the passport appears to match the individual appearing at the biometric data collection station;
collecting biometric data of the individual; and
storing said biometric data such that said biometric data is linked with said database record.

18. The method of claim 17 wherein said biometric data is iris recognition data.

19. The method of claim 17 comprising the further step of determining, following said receiving personal data step and prior to use by the individual of the biometric recognition system for passport control, whether the individual meets predetermined qualifications for using the biometric recognition system for passport control and permitting use of the biometric recognition system only if the individual meets said predetermined qualifications.

20. The method of claim 19 including the further step of notifying the individual of the results of said step of determining whether the individual meets predetermined qualifications.

21. The method of claim 17 including the further step of using an automatic passport reader at the biometric data collection station to read information from the passport and using data from said automatic passport reader to locate said database record for comparison.

22. The method of claim 21 comprising the further step of determining, following said receiving personal data step and prior to use by the individual of the biometric recognition system for passport control, whether the individual meets predetermined qualifications for using the biometric recognition system for passport control and permitting use of the biometric recognition system only if the individual meets said predetermined qualifications.

23. The method of claim 22 wherein said step of storing biometric data of the individual is completed only if the individual meets said predetermined qualifications.

24. The method of claim 17 wherein said plurality of stations are connected to a wide area computing network and said step of receiving personal data over the computer network is accomplished using at least one server connected to said wide area computing network.

25. The method of claim 24 wherein said server includes web server software and said data entry form is provided using a web browser.

26. The method of claim 25 wherein said wide area computing network is the Internet.

27. The method of claim 17 including the further step of storing an indication in response to verification that the passport appears to match the individual.

28. The method of claim 27 wherein said indication is stored in said database record.

29. The method of claim 27 wherein said function of verifying that the passport appears to match the individual is performed by human examination.

30. The method of claim 27 comprising the further step of denying the individual passage through the biometric recognition system for passport control in the absence of storage of said indication that the passport appears to match the individual.

31. A method for enrolling an individual in a biometric recognition system for passport control, comprising the steps of:
providing an electronic application form at a plurality of stations through a computer network allowing entry of predetermined personal data including at least a passport number from a passport held by the individual, and having a submission feature for transmitting the personal data as an application to use said biometric recognition system for passport control;
receiving said application from an individual over the computer network;
determining, based on said personal data, whether the individual meets predetermined qualifications for using the biometric recognition system for passport control and if so, storing said personal data in a database record in a manner indicating approval of the individual;
receiving the individual together with said passport at a biometric data collection station;
verifying a match between said passport number and the passport number entered by the individual in said data entry form;
verifying that the passport appears to match the individual appearing at the biometric data collection station;
collecting biometric data of the individual; and
storing said biometric data such that said biometric data is linked with said database record.

32. The method of claim 31 wherein iris pattern data is collected in said step of collecting biometric data of the individual.

33. A method for enrolling and identifying a traveler using a biometric recognition system, comprising the steps of:
placing an identity document of the individual in an identity document reader;
receiving machine readable personal data identifying the individual from said identity document reader;
storing said personal data in a database;
receiving the individual together with said identity document at a biometric data collection station;
verifying a match between said identity document and the individual; and
collecting biometric data of the individual and storing said biometric data such that said biometric data is linked with said personal data stored in said database.

34. The method of claim 33 comprising the further step of determining, following said receiving machine readable personal data step and prior to use by the individual of the biometric recognition system, whether the individual meets predetermined qualifications for using the biometric recognition system and permitting use of the biometric recognition system only if the individual meets said predetermined qualifications.

35. The method of claim 34 wherein said biometric recognition system is a passport control system for national entry, said identity document is a passport, and a check of the individual against one or more watch lists is performed prior to permitting said individual to use the passport control system.
